(19) United States
(12) Patent Application Publication
(10) Pub. No.: US 2013/0136002 A1
(43) Pub. Date: May 30, 2013

(54) APPARATUS AND METHOD FOR TRANSMITTING DATA AND METHOD FOR DETERMINATION OF TRANSMISSION RATE

(71) Applicant: SAMSUNG SDS CO., LTD., Seoul (KR)

(72) Inventors: Sung-Hak Song, Seongnam-si (KR); Kyung-Eun Woo, Yongin-si (KR); Chang-Hoon Lee, Yongin-si (KR); Kyu-Sam Oh, Seoul (KR); Jin-Bum Hwang, Seoul (KR)

(73) Assignee: SAMSUNG SDS CO., LTD., Seoul (KR)

(21) Appl. No.: 13/689,856

(22) Filed: Nov. 30, 2012

(30) Foreign Application Priority Data
Nov. 30, 2011 (KR) 10-2011-0126968

(51) Int. Cl. H04L 12/56

(52) U.S. Cl. CPC H04L 47/25
USPC 370/235; 370/431; 370/253

(57) ABSTRACT

Disclosed is a data transmitter including: a plurality of write tasks configured to transmit data in parallel to a receiver over a network; and a control task configured to control the plurality of write tasks so that the plurality of write tasks are operated in a fixed transmission rate operation mode or a variable transmission rate operation mode in which a transmission rate varies depending on network conditions. Thus, network bandwidth can be efficiently shared with cross traffic even when a parallel TCP stream is used.

### CROSS-REFERENCE TO RELATED APPLICATION

This application claims priority from Korean Patent Application No. 10-2011-0126968, filed on Nov. 30, 2011, the disclosure of which is incorporated herein by reference in its entirety.

### BACKGROUND

1. Field of the Invention

Exemplary embodiments relate to an apparatus and method for transmitting data, a method for determination of a transmission rate, and a recording medium.

2. Discussion of Related Art

Data transmission and reception technology using a single TCP stream has inefficiency in that a transmission rate rapidly decreases and network bandwidth is not sufficiently used when the network path has a long round trip time (RTT) and a high packet loss rate. To solve this problem, there is data transmission and reception technology using parallel TCP streams. However, this technology has a problem in that the transmission rate of cross traffic is significantly reduced due to the aggressive occupation of the network bandwidth.

### SUMMARY

Exemplary embodiments are directed to providing a data transmission apparatus and method that can use parallel TCP streams but efficiently share network bandwidth with cross traffic.

Exemplary embodiments are also directed to providing a data transmission apparatus and method that can prevent a transmission rate of cross traffic from being significantly reduced by effectively utilizing the network bandwidth when there is no cross traffic and decreasing network bandwidth usage by policy when the cross traffic is introduced.

Exemplary embodiments are also directed to providing a data transmission apparatus and method for transmitting data on the basis of 4 operation modes depending on network conditions.

Exemplary embodiments are also directed to providing a data transmission apparatus and method based on parallel TCP stream, in which a transmission rate varies depending on the network conditions.

According to an aspect of one or more exemplary embodiments, there is provided a data transmitter apparatus comprising, a processing unit; and a memory storing instructions enabling the processor to implement, a plurality of write tasks configured to transmit data in parallel over a network to a receiver; and a control task configured to control the plurality of write tasks to operate in one of a fixed transmission rate operation mode, and a variable transmission rate operation mode in which a transmission rate varies depending on network conditions.

The variable transmission rate operation mode may include at least one of a minimum transmission rate operation mode, a fair transmission rate operation mode, and a multiple transmission rate operation mode.

In the minimum transmission rate operation mode, the plurality of writer tasks may transmit data at a variable transmission rate depending on network conditions, which is greater than a predetermined minimum transmission rate.

In the fair transmission rate operation mode, any one of the plurality of write tasks may transmit data according to a congestion control method of a data communication protocol between the transmitter and the receiver, and the others of the plurality of write tasks may transmit data at the variable transmission rate depending on network conditions.

In the multiple transmission rate operation mode, n (where n is a positive integer less than a number of write tasks) of the plurality of write tasks may transmit data according to a congestion control method of a data communication protocol between the transmitter and the receiver, and the others of the plurality of write tasks may transmit data at the variable transmission rate depending on network conditions.

A data communication protocol between the transmitter and the receiver may be a transmission control protocol (TCP).

Each of the plurality of socket writer tasks may has an ID which is a positive integer sequentially given from 1, the each of the plurality of write tasks may compare its own ID with an operation mode indication value n to determine their own operation mode, and the value n may be delivered from the control task.

The plurality of socket writer tasks may each have an ID (where the ID is a positive integer) sequentially given from 1, the plurality of write tasks may each compare their own ID with an operation mode indication value n to determine their own operation mode, and the value n may be delivered from the control task.

Among the plurality of write tasks, a write task having an ID equal to or less than the value n may transmit data according to a congestion control method of a data communication protocol between the transmitter and the receiver, and a write task having an ID greater than the value n may transmit data at the transmission rate determined by the control task.

When the plurality of write tasks operate in the variable transmission rate operation mode, the control task may control transmission rates of the plurality of writer tasks based on an amount of data waiting during a transmission control period in at least one queue on a path where the data is transmitted over the network.

The amount of data waiting in the queue may be calculated using QLength=(MeanQueueDelay−MinFDelay)×AvgRxRate, where MeanQueueDelay is an average value of forward delays during the current transmission control period, MinFDelay is an minimum value among forward delays up to the current transmission control period from a transmission start time, and AvgRxRate is an average data reception rate during the current transmission control period.

The average data reception rate may be a value obtained by dividing an amount of data received by the receiver during the current transmission control period by the transmission control period.

The amount of data received by the receiver during the current transmission control period may be a value obtained by subtracting an amount of data received by the receiver up to the previous transmission rate control time from the transmission start time from the amount of data received from the receiver up to the current transmission control period from the transmission start time.

The data transmitter may further include a probe task configured to transmit a probe packet to the receiver and receiving a probe response packet from the receiver, wherein the probe response packet includes i) an amount of data transmitted to the receiver during the current transmission control period or information required for calculation of the amount of data and ii) a forward delay of the probe packet.

The probe task may transmit the probe packet and receive the probe response packet with a user datagram protocol (UDP).

The probe task may transmit a plurality of probe packets and receive the probe response packet to each probe packet during the current transmission control period.

The probe packet may include its own transmission time.

According to another aspect of one or more exemplary embodiments, there is provided A data transmitter apparatus comprising a processing unit, and a memory storing instructions enabling the processor to implement a plurality of write tasks configured to transmit data in parallel over a network to a receiver, and a control task configured to control a data transmission rate of one or more of the plurality write tasks.

The control task may calculate an amount of data using QLength=(MeanQueueDelay−MinFDelay)×AvgRxRate, where MeanQueueDelay is an average value of forward delays during a current transmission control period, MinFDelay is an minimum value among forward delays up to the current transmission control period from a transmission start time, and AvgRxRate is an average data reception rate during the current transmission control period, and at least one of the plurality of write tasks may transmit the amount of data at data transmission periods.

The data transmitter may further include a probe task configured to transmit a probe packet to the receiver and receiving a probe response packet from the receiver, wherein the probe response packet includes i) an amount of data transmitted to the receiver during the current transmission control period or information required for calculation of the amount of data and ii) a forward delay of the probe packet.

When the plurality of write tasks operate in the variable transmission rate operation mode, the control task may control transmission rates of the plurality of writer tasks on the basis of an amount of data waiting during a transmission control period in at least one queue on a path where the data is transmitted over the network.

The control task may calculate the amount of data waiting during a current transmission control period in at least one queue, and determine a transmission rate of a next transmission control period according to comparison the calculated amount of data with a threshold value.

According to still another aspect of exemplary embodiments, there is provided a data transmission method including, transmitting data in parallel, by a plurality of writer tasks of a transmitter, to a receiver over a network, and setting a transmission rate of the data based on network conditions, wherein the transmitting of the data comprises transmitting the data in one of a fixed transmission rate operation mode, and a variable transmission rate operation mode comprising setting the transmission rate based on network conditions.

According to yet another aspect of one or more exemplary embodiments, there is provided a data transmission rate determination method of a data transmitter configured to transmit data over a network, the method comprising, calculating an amount of queue wait data, waiting during a transmission control period, in at least one queue, on a path where the data is transmitted over the network; and setting the data transmission rate based on the amount of queue wait data.

According to yet another aspect of one or more exemplary embodiments, there is provided a computer readable medium recording a program for executing the above-described method.

### BRIEF DESCRIPTION OF THE DRAWINGS

The above and other objects, features and advantages of exemplary embodiments will become more apparent to those of ordinary skill in the art by describing in detail exemplary embodiments thereof with reference to the attached drawings, in which:

FIG. 1 is a view illustrating a data transmitter and a data receiver according to an exemplary embodiment;

FIG. 2 is a view illustrating functions of the data transmitter and the data receiver of FIG. 1;

FIG. 3 is a view illustrating a data transmission method according to an exemplary embodiment;

FIG. 4 is a view illustrating a probe packet according to an exemplary embodiment;

FIG. 5 is a view illustrating a probe response packet according to an exemplary embodiment;

FIG. 6 is a flow chart illustrating a transmission method according to another exemplary embodiment;

FIG. 7 is a view illustrating a probe packet according to an exemplary embodiment;

FIG. 8 is a flow chart illustrating a method of calculating a transmission rate according to an exemplary embodiment; and

FIG. 9 is a view illustrating a computer readable recording medium according to an exemplary embodiment.

### DETAILED DESCRIPTION OF EXEMPLARY EMBODIMENTS

The objects, other objectives, features, and advantages of the inventive concept will be understood without difficulties through preferred embodiments below related to the accompanying drawings. The inventive concept may, however, be embodied in different forms and should not be construed as limited to the embodiments set forth herein. Rather, these embodiments are provided so that this disclosure will be thorough and complete, and will fully convey the scope of the disclosure to those skilled in the art. In this specification, it will also be understood that when another component is referred to as being ‘on’ one component, it can be directly on the one component, or an intervening third component may also be present.

It will also be understood that when an element (or component) is referred to as being operated or executed on another element (or component), the element (or component) is operated or executed in environments where the other element (or component) is operated or executed or through direct or indirect interaction with the other element (or component).

It will also be understood that when any element, component, apparatus, or system is referred to as including a component configured with a program or software, even when not explicitly referenced, the element, component, apparatus, or system includes hardware (for example, memory, CPU, etc.) or other program or software (for example, operating system or driver for driving hardware).

It will also be understood that unless implementation of any element (or component) is specifically mentioned, the element (or component) may be implemented in various forms such as hardware, software, or a combination thereof.

In the following description, the technical terms are used only for explaining a specific exemplary embodiment while not limiting the inventive concept. The terms of a singular form may include plural forms unless specifically mentioned. The meaning of ‘comprises’ and/or ‘comprising’ does not exclude other components besides a mentioned component.

Hereinafter, exemplary embodiments will be described with reference to the accompanying drawings. In the description of the specific embodiment below, several specific contents are provided to describe in detail of the exemplary embodiments to aid the understanding thereof. However, a reader skilled in the art will recognize that the exemplary embodiments may be used even without these several specific contents. For simplicity and clarity, description of parts that are well known, but not greatly associated with the exemplary embodiments, will be omitted.

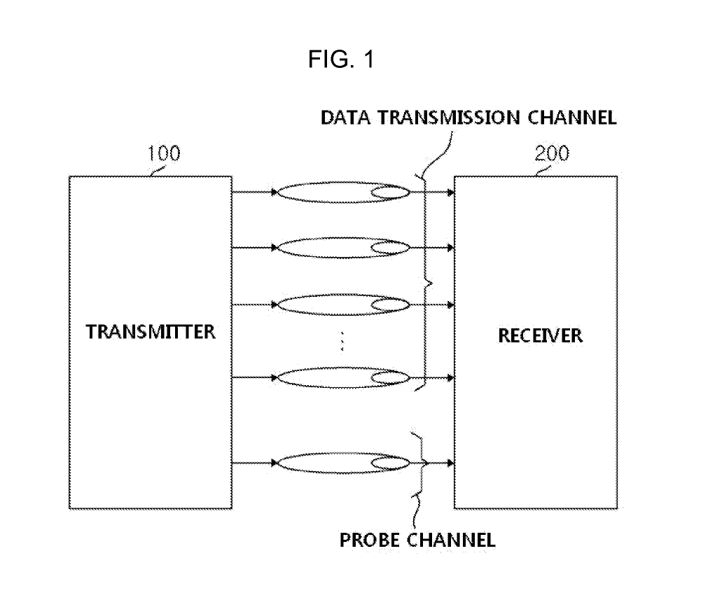

FIG. 1 illustrates a data transmitter and a data receiver according to an exemplary embodiment.

Referring to FIG. 1, the data transmission and reception apparatus includes a transmitter 100 transmitting data and a receiver 200 receiving data.

According to an exemplary embodiment, the transmitter 100 and receiver 200 may transmit and receive data over a data transmission channel and a probe channel.

According to an exemplary embodiment, the data transmission channel is a channel for transmitting and receiving data with a communication protocol such as Transmission Control Protocol (TCP), and the probe channel is a channel for transmitting and receiving data with a communication protocol such as User Datagram Protocol (UDP). It should be noted that these communication protocols are exemplary, and not limited to TCP and UDP. It is desirable that a communication protocol capable of being used instead of the UDP be a protocol that disallows retransmission such as the UDP.

According to an exemplary embodiment, information regarding network conditions may be acquired through the probe channel. For example, the information regarding network conditions may be acquired through a probe packet and a response packet of the probe packet that are transmitted and received through the probe channel.

According to an exemplary embodiment, the transmitter 100 may transmit data in parallel to the receiver 200 and may transmit data in a fixed transmission rate operation mode or a variable transmission rate operation mode in which the transmission rate varies depending on the network conditions.

According to an exemplary embodiment, the transmitter 100 may operate in any one of the fixed transmission rate operation mode and the variable transmission rate operation mode in which the transmission rate varies depending on the network conditions. The variable transmission rate operation mode includes a minimum transmission rate operation mode, a fair transmission rate operation mode, and a multiple transmission rate operation mode.

According to an embodiment of, the operation mode may be determined by a manager of either a transmitter or a receiver, and the transmitter 100 operates according to the operation mode determined by the manager. Determination of the operation mode by the manager is exemplary, and the present disclosure is not limited thereto. The operation mode may be determined by other conditions, not by the manager. For example, the operation mode may be determined in various ways, such as according to an event or schedule or depending on network conditions. Hereinafter, operation modes will be described.

In the fixed transmission rate operation mode, data is transmitted at a constant transmission rate, and a portion of the network bandwidth corresponding to the predetermined rate is used while the rest of the network bandwidth is used for the cross traffic.

The minimum transmission rate operation mode is an operation mode in which the transmission rate varies depending on network conditions but a minimum of the transmission rate is guaranteed. In the minimum transmission rate operation mode, the network bandwidth may be maximally used when there is no cross traffic, and the network bandwidth is allowed for the cross traffic but the predetermined minimum transmission rate is secured when there is the cross traffic.

The fair transmission rate operation mode is an operation mode in which the network bandwidth is maximally used when there is no cross traffic, and the network bandwidth is used at the same ratio as the cross traffic when there is a cross traffic. For example, any one of a plurality of write tasks included in the transmitter 100 may transmit data according to a congestion control method of a data communication protocol between a transmitter and a receiver, for example, TCP, while the others of the plurality of write tasks may transmit data using a variable transmission rate depending on the network conditions.

The multiple transmission rate operation mode is an operation mode in which the network bandwidth is maximally used when there is no cross traffic, and the network bandwidth is used at a certain multiple of the cross traffic when there is a cross traffic. For example, n write tasks (where n is a positive integer less than the number of write tasks) among a plurality of write tasks included in the transmitter 100 may transmit data according to a congestion control method of the TCP, while the rest of the write tasks may transmit data using a variable transmission rate depending on the network conditions.

The multiple transmission rate operation mode may use at least n times the bandwidth used by the cross traffic. In the minimum transmission rate operation mode, the network bandwidth is maximally used when there is no cross traffic, and at least n times the bandwidth used by the cross traffic can be guaranteed when there is the cross traffic.

According to an exemplary embodiment, the transmitter 100 may determine the transmission rate based on an amount of data waiting in a queue (or queues) in a path on the network between the transmitter 100 and the receiver 200, and transmit data to the receiver 200 at the determined transmission rate. The amount of data waiting in a queue(s) in the path is the amount of the data waiting during one transmission control period, and can be estimated by the transmitter 100 through the probe channel.

In this specification, “transmission control period” means a period in which a control task determines a transmission rate, and “transmission period” means a period in which the write tasks write data on a socket according to an amount of writebytes. The transmission control period may be the same as the transmission period, or not.

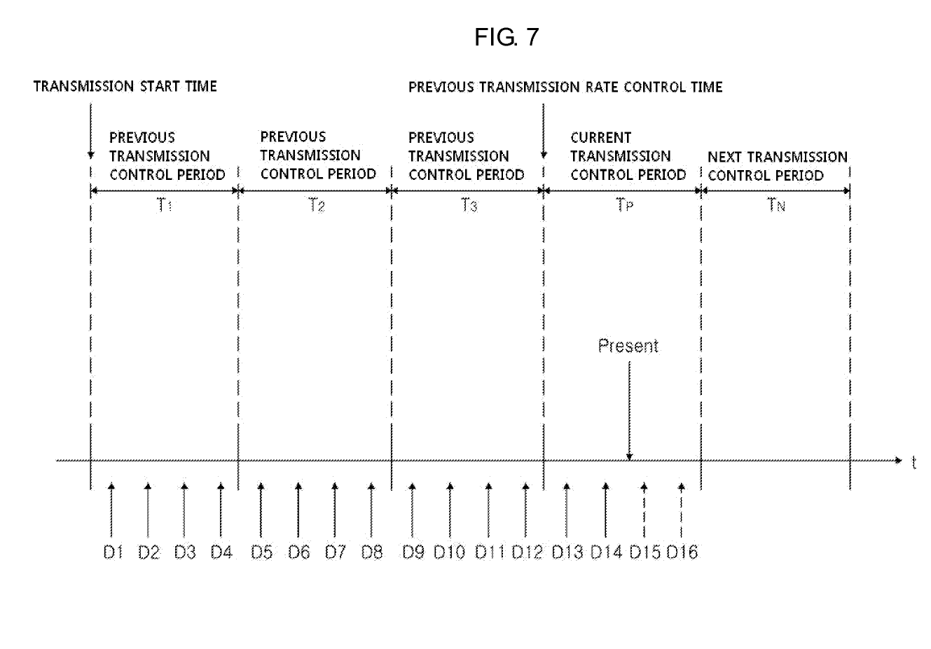

FIG. 7 is a view illustrating a probe packet according to an exemplary embodiment. Referring to FIG. 7, the transmitter 100 transmits data according to a data transmission rate reflecting network condition for each transmission control period T. In calculation of a transmission rate for transmitting data in ‘next transmission control period,’ the transmitter 100 calculates the amount of data waiting in a queue (or queues) on a data transmission path on a network in a ‘current transmission control period,” and then determines the transmission rate on the basis of the amount of data.

According to an exemplary embodiment, the transmitter 100 may calculate the amount of data waiting in a queue (or queues) of a data transmission path on a network, using the following equations.

QLength=AvgQueueDelay×AvgRxRate [Equation 1]

where QLength is an amount of data waiting in a queue (or queues) of a data transmission path on a network during a ‘current transmission control period,’AvgQueueDelay is an average queueing delay, and AvgRxRate is an average data reception rate during the ‘current transmission control period’.

The average queueing delay (AvgQueueDelay) may be calculated using equation 2.

AvgQueueDelay=MeanQueueDelay−MinFDelay [Equation 2]

where MeanQueueDelay is an average value of forward delays during ‘current transmission control period,’ and MinFDelay is a minimum value among forward delays from a transmission start time to the ‘current transmission control period’ (that is, before the next transmission control period starts.)

The transmitter 100 may transmit probe packets to the receiver 200 through the probe channel several times and receive a probe response packet for each probe packet from the receiver 200 to calculate each forward delay. MeanQueueDelay is an average value of these forward delays.

Also, the transmitter 100 stores and keeps a minimum value among forward delays calculated through the probe channel from the transmission start time as MinFDelay. When the transmitter 100 acquires a new forward delay, the transmitter 100 compares the new forward delay with previously stored MinFDelay. If the new forward delay is less than the previously stored MinFDelay, the transmitter 100 stores the new forward delay as MinFDelay instead of the previously stored minimum forward delay.

AvgRxRate may be calculated as an average data reception rate during ‘current transmission control period,’ using equation 3.

AvgRxRate=Recvbytes/transmission control period [Equation 3]

where Recvbytes is an amount of data received by the receiver 200 from the transmitter 100 during a transmission control period.

The transmitter 100 according to an exemplary embodiment calculates QLength (hereinafter referred to as ‘an amount of queue wait data’), using the above-described exemplary equations, and determines the transmission rate on the basis of this value.

For example, the transmitter 100 compares the amount of queue wait data with a certain threshold value, and set the transmission rate of the next transmission control period to be less than the transmission rate of the current transmission control period when the amount of queue wait data is greater than the threshold value, and set the transmission rate of the next transmission control period to be greater than the transmission rate of the current transmission control period when the amount of queue wait data is less than the threshold value.

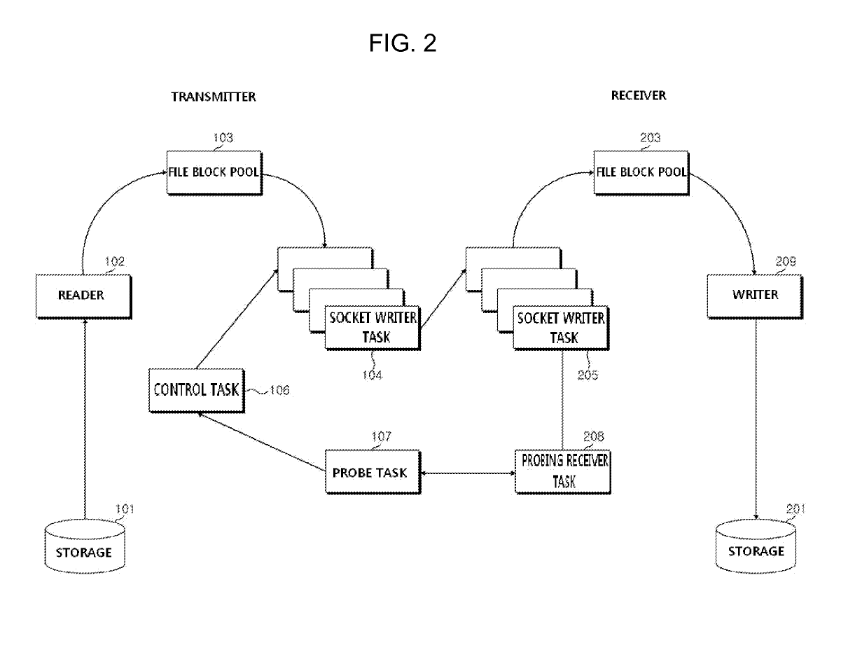

More specifically, for example, the transmitter 100 may multiply the transmission rate of the current transmission control period by a number greater than 1 to set the transmission rate of the next transmission control period when the amount of queue wait data is less than the threshold value, and may multiply the transmission rate of the current transmission control period by a number greater than 0 and less than 1 to set the transmission rate of the next transmission control period when the amount of queue wait data is greater than the threshold value. The method of deciding the transmission rate will be described in detail below with reference to FIGS. 2 and 7.

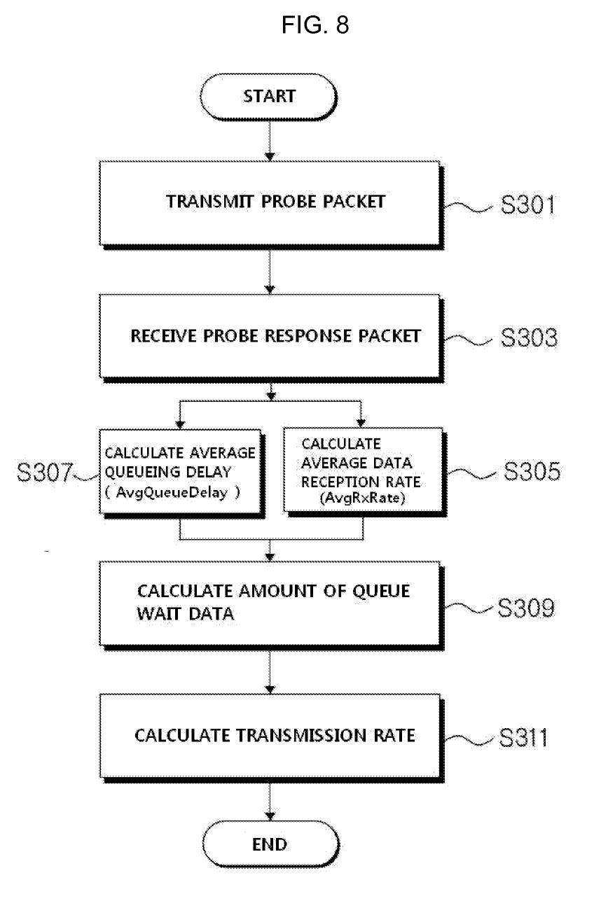

According to an exemplary embodiment, the transmitter 100 transmits a probe packet to the receiver 200 through the probe channel and receives a probe response packet from the receiver 200. As shown in FIG. 8, the transmitter 100 may transmit multiple probe packets during one transmission control period and receive a probe response packet for each probe packet. FIG. 8 illustrates and example in which 4 probe packets are transmitted for each transmission control period. However, it will be apparent to one of ordinary skilled in the art that the number is merely exemplified, and may be more or less than 4.

FIG. 4 illustrates an example of a probe packet, and FIG. 5 illustrates an example of a probe response packet. Referring to these drawings, the probe packet includes a transmission time (sendtime), that is, a time at which data is transmitted from the transmitter 100 to the receiver 200, and the probe response packet includes the total amount of data received by the receiver 200 (Recvbytes) up to a current probe packet reception time from a transmission start time, and a forward delay (forwardDelay) of the probe packet.

The receiver 200 calculates a forward delay for each packet on the basis of the transmission time included in the probe packet. That is, the receiver 200 calculates the forward delay through the difference between a reception time of the probe packet and the transmission time included in the probe packet.

Also, the receiver 200 stores the total amount of received data (TotRecvbytes) received from a transmission start time and adds the total amount of received data (TotRecvbytes) and the forward delay for the probe packet to the probe response packet, and transmit the probe response packet to the transmitter 100.

The transmitter 100 may calculate the amount of data received (Recvbytes) by the receiver during the current transmission control period through the difference between a total amount of received data included in a probe response packet received finally in the current transmission control period and a total amount of received data included in a probe response packet received in the previous transmission control period. As described above, an average data reception rate (AvgRxRate) is calculated by dividing Recvbytes by the transmission control period.

FIG. 2 is a view illustrating functions of the data transmitter and receiver of FIG. 1.

Referring to FIG. 2, the transmitter 100 may include a storage 101, a reader 102, a file block pool 103, a plurality of socket writer tasks 104 (hereinafter referred to as ‘writer tasks’), a control task 106, and a probe task 107. The receiver 200 may include a storage 201, a file block pool 203, a plurality of socket reader tasks 205 (hereinafter, ‘reader tasks’), a probing receiver task 208, and a writer 209. Hereinafter, these components will be described in detail with reference to FIG. 2.

Referring to FIG. 2, the storage 101 has files to be transmitted, and the reader 102 reads data in a certain unit from the storage 101 to form a file block and then store the file block in the file block pool 103. This operation is repeated until all the files to be transmitted are read.

Each of the plurality of writer tasks 104 checks whether the file block pool 103 has a file block, and transmit the file block to the receiver 200 if the file block pool 103 has the file block. In this case, each of the plurality of writer tasks 104 simultaneously takes charge of each of the communication stream (for example, TCP stream), and transmit data to the receiver 200 in parallel.

According to an exemplary embodiment, the plurality of writer tasks 104 each have a unique ID, where the ID may be a natural number from 1 to N (here, N is the total number of streams) that is sequentially given to the writer task in order of generation time.

The receiver 200 receives data from the transmitter 100 and stores the data in the storage 201. For example, the plurality of reader tasks 205 of the receiver 200 receive data from the writer tasks 104 of the transmitter 100 in parallel and then record the data in the file block pool 203. The reader tasks 205 repeat this operation until the file transmission is completed.

The writer 209 checks whether the file block pool 203 has a file block, and reads and stores the data in the storage 210 if the file block pool 203 has the file block. When the record of all files is completed and thus the file transmission is completed, the writer 209 transmits an end signal to the transmitter 300.

According to an exemplary embodiment, the storage reader 102/the storage writer 109 and the socket writer task 104/the socket reader task 205 in the above described file transmission/reception processes may be simultaneously operated using multithreading.

Control of the transmission rate in the transmitter or receiver may be performed through interaction between the writer task 104, the control task 106, the probe task 107, and the probing receiver task 208.

According to an exemplary embodiment, the transmission rate in the writer task 104 may be determined depending on not only a communication protocol (for example, TCP) between a transmitter and a receiver but also network conditions.

A method of determining the transmission rate according to an exemplary embodiment of will be described assuming that there are N writer tasks 104.

In the fixed transmission rate operation mode, the N writer tasks 104 all transmit data at a fixed transmission rate, irrespective of network conditions.

In the minimum transmission rate operation mode, the N writer tasks 104 all transmit data at a variable transmission rate depending on the network conditions. However, a minimum transmission rate is securely kept no matter how bad the network condition becomes.

In the fair transmission rate operation mode, only one of the N writer tasks 104 has a transmission rate controlled by the communication protocol (for example, TCP) between the transmitter and receiver, while the others of the plurality of writer tasks have variable transmission rates depending on network conditions.

In the multiple transmission rate operation mode, n writer taskes (n<=N) of the N writer tasks 104 each have a transmission rate controlled by the communication protocol (for example, TCP) between the transmitter and the receiver, while the rest of the writer tasks have variable transmission rates depending on network conditions. Here, the number n may be determined by a manager of the data transmitter or receiver. For example, for transmission bandwidth 3 times greater than cross traffic, the n is ‘3’, and only 3 of the writer tasks 104 each have a transmission rate controlled by the communication protocol (for example, TCP) between the transmitter and receiver, while N−3 writer tasks have variable transmission rates depending on network conditions.

The variable transmission rate depending on network conditions means that, for example, the transmission rate varies on the basis of the above-described amount of queue wait data.

The control task 106 delivers an operation mode indication value n to the socket writer tasks 104. The socket writer tasks 104 determine their own operation modes on the basis of the value n.

For example, among the plurality of write tasks 104, a write task having an ID equal to or less than the value n for operation mode indication transmits data according to a congestion control method of a data communication protocol between a transmitter and a receiver.

Meanwhile, a write task having an ID greater than the value n transmits data according to a transmission rate determined depending on network conditions. Here, the value n may be received by the transmitter 100 or the receiver 200 from the manager that manages the transmitter and receiver, or determined according to a predetermined event or schedule. In the case of being received by the receiver 200, the value n may be delivered to the control task 106 of the transmitter 100.

According to an exemplary embodiment, the control task 106 delivers the amount of data (writebytes) to be written by each writer task 104 to the socket, and the value n, to the writer task 104. Here, writebytes is the amount of data to be transmitted by each writer task 104 during its transmission period, which may vary depending on network conditions.

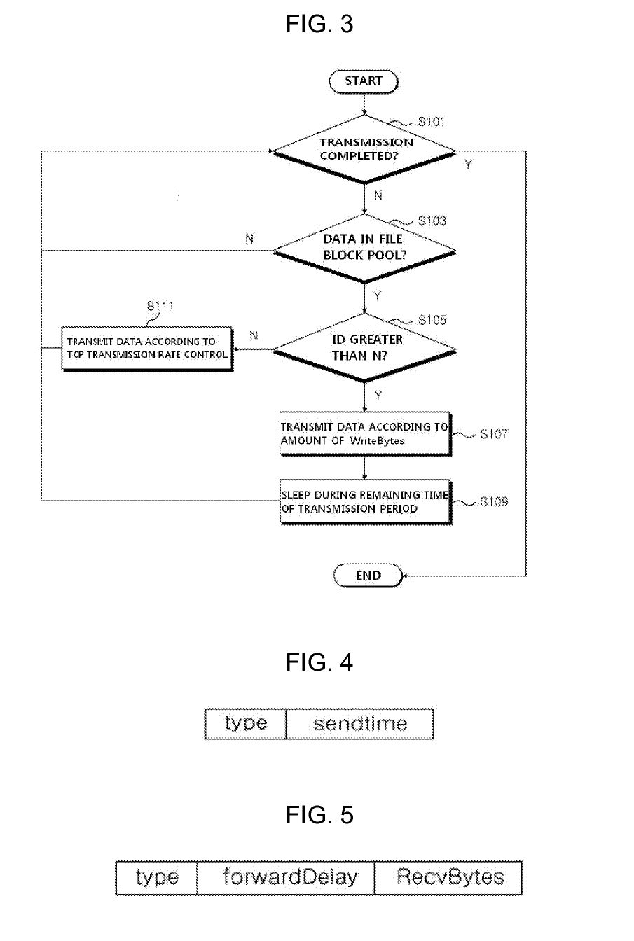

The operation of the writer tasks 104 will be described in detail with reference to FIG. 3.

Referring to FIG. 3, the writer tasks 104 each check whether file transmission is fully completed (S101). If the file transmission is not completed (S101: N), the writer tasks 104 each check whether the file block pool has data to be transmitted (S103). If the file block pool has no data to be transmitted (S103: N), the operation returns to step S101. Meanwhile, if the file transmission is fully completed (S101: Y), the operation ends here.

On the other hand, if the file block pool has the data to be transmitted (S103: Y), the writer tasks 104 each compare their own ID with n (value for operation mode indication) (S105). If the ID is not greater than n (S105: N), the writer task 104 transmits data according to the control of the TCP transmission rate.

If the ID is greater than n (S105: Y), the writer tasks 104 transmit data according to the amount of writerBytes (S107) and perform operation S101 again after sleep during the remaining time of the transmission period.

According to the above-described operations, TCP sessions of the writer tasks having IDs equal to or less than n each compete with cross traffic and share network bandwidth with the cross traffic. TCP sessions of N−n writer tasks having IDs greater than n increase the transmission rate to occupy idle bandwidth when there is the idle bandwidth of the network, but allow the cross traffic to use the network bandwidth when there is no idle bandwidth due to network congestion.

According to an exemplary embodiment, the control task 106 stores and manages information regarding network conditions delivered from the probe task 107, and calculates a value (writerBytes) for each of the transmission control periods based on the information to deliver the value to the writer tasks 104. As described above, the information regarding network conditions includes a forward delay in a network path between the transmitter 100 and the receiver 200 and a total amount of data (for example, number of bytes) received by the receiver 200 from the transmitter 100 by the current transmission control period.

The forward delay is a time taken for a packet to be transmitted from the transmitter 100 to the receiver 200, which includes a queue wait time which is varying depending on network conditions in addition to a processing time and transmission delay time constantly occurring when the packet is transmitted. The queue wait time may increase as the number of packets piled in a queue increases and decrease as the number of packets decreases. Accordingly, if the queue wait time increases, it means that excessive packets are flown into the network.

According to an exemplary embodiment, once the transmission starts, the probe task 107 transmits the probe packet to the receiver 200 until the transmission is completed.

Referring to FIG. 7, it will be appreciated that the probe packets D1 to D16 are exemplarily shown, and 4 probe packets are transmitted for each of the transmission control periods. In response to each probe packet, the probing receiver task 208 transmits a probe response packet (not shown) to the probe task 107. Information included in the probe packet and the probe response packet has been described with reference to FIGS. 3 and 4. Thus, the detailed description thereof will be omitted.

The probing receiver task 208 calculates the forward delay through the difference between a transmission time (sendtime) included in the probe packet and a time when the probe packet is received, and receives the total amount of data (TotRecvbytes) received from the transmitter (for example, number of bytes) from the socket reader tasks 205. Hereinafter, the probing receiver task 208 adds the forward delay and the total amount of received data to the probe response packet and then delivers the packet to the transmitter 100.

The probe task 107 delivers the total amount of received data and the forward delay included in the probe response packet received from the probing receiver task 208, to the control task 106.

The control task 106 may store and manage the forward delay and the total amount of received data whenever receiving them from the probe task 107 to determine an average network condition during the corresponding transmission control period.

For example, to determine the network condition, the control task 106 stores and maintains a minimum value of the forward delay (MinFDelay) received from the probe task 107 from a data transmission start time, and assumes the minimum value as a forward delay when there is enough network bandwidth, that is, optimal forward delay with no queue wait time.

The minimum value (MinFDelay) stored and maintained based on the present is a forward delay having a minimum value among the probe packets D1 to D14 transmitted up to the present.

To provide a description of a method of determining a transmission rate with reference to FIG. 7, the control task 106 may calculate the transmission rate from probe packets D1 to D16 up to a time at which the current transmission control period is completed and the probe response packets of the probe packets.

The control task 106 calculates the average queueing delay (AvgQueueDelay), using equation 2. That is, the control task 106 calculates the difference between the minimum value among the forward delays of the probe packets D1 to D16 and an average value of the probe packets D13 to D16, as an average queueing delay.

Also, the control task 106 calculates the total amount of data received by the receiver 200 during the current transmission control period T3 through the difference between a total amount of received data up to a transmission control period T4 and a total amount of received data up to a current transmission control period T3. Here, the total amount of received data up to T4 may be included in the probe response packet of the probe packet D16, and the total amount of received data up to T3 may be included in the probe response packet of the probe packet D12.

Then, the control task 106 may calculate the amount of queue wait data using equation 1, and determine the transmission rate depending on the operation modes of the writer tasks 104 on the basis of the calculated amount of queue wait data.

For example, the control task 106 determines the writer tasks having a transmission rate to be controlled by a TCP communication protocol and the writer tasks having the transmission rate to be controlled depending on the network conditions, among the writer tasks 104, according to the value n for operation mode indication. Here, n is set to 0 in the minimum transmission rate operation mode and the fixed transmission rate operation mode, n is set to 1 in the fair transmission rate operation mode, and n is set to a predetermined multiple in the multiple transmission rate operation mode.

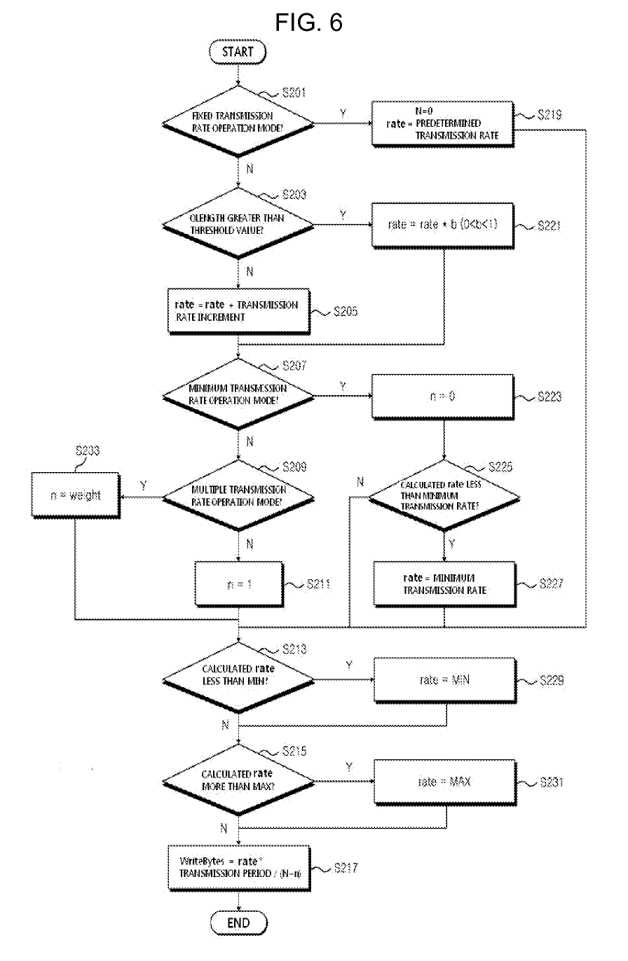

The control task 106 calculates the transmission rate to be transmitted to the N-n writer tasks having the transmission rate to be controlled depending on the network conditions. Here, a method of calculating the transmission rate will be described in detail with reference to FIG. 6.

The control task 106 also calculates a total amount of data to be transmitted by N−n writer tasks, by multiplying the transmission control period by the calculated transmission rate. Furthermore, the control task 106 calculates an amount of data to be transmitted by each writer task at transmission periods by dividing the total amount of data by N−n, and then transmits the amount of data to N−n writer tasks, except for the writer tasks having the transmission rate controlled by the TCP communication protocol.

FIG. 6 is a view illustrating a transmission method according to another exemplary embodiment.

Referring to FIG. 6, the transmitter 100 allocates a variable n to 0 (S201) and allocates the predetermined transmission rate to a variable rate (S219) in a fixed transmission rate mode. Then, the control task 106 determines writerBytes through steps S213 and S215 (S217).

The control task 106 compares the amount of queue wait data (QLength) with a predetermined threshold value (S203), and if the amount of queue wait data is greater than the threshold value (S203: Y), multiplies a value b (0≦b≦1) by the transmission rate in the previous transmission control period to allocate the value to the rate (S221).

If the amount of queue wait data (QLength) is not greater than the threshold value (S203: N), the control task 106 adds an increment of a certain amount to the transmission rate in the previous transmission control period to allocate the value to the rate (S205). Here, the increment may be a constant, or a variable that changes depending on situations.

The control task 106 sets n=0 in the minimum transmission rate operation mode (S207: Y), and then determines whether the rate set in step S221 or S205 is less than the minimum transmission rate (S225).

If the rate set in step S221 or S205 is less than the minimum transmission rate (S225: Y), the control task 106 allocates the minimum transmission rate to the rate (S227) and performs operations S213, S215, and S217. If the rate set in step S221 or S205 is not less than the minimum transmission rate (S225: N), the control task 106 performs operations S213, S215, and S217 but not S227.

If the operation mode is not the minimum transmission rate operation mode (S207, N), the control task 106 determines whether the operation mode is the multiple transmission rate operation mode (S209).

If the operation mode is the multiple transmission rate operation mode (S209, Y), the control task 106 sets a weight (Weight) as n (S233). If the operation mode is not the multiple transmission rate operation mode (S209: N), the control task sets n=1 (S211).

When the rate calculated in the above steps is less than a minimum transmission rate (MIN) (S213: Y), the control task 106 sets the minimum transmission rate to the rate (S229). Also, when the rate calculated in the above steps is greater than the maximum transmission rate (MAX) (S215: Y), the control task 106 sets the maximum transmission rate to the rate (S231).

Then, the control task 106 calculates writerBytes by multiplying a transmission period by the rate and then dividing it by N−n (S217), and delivers writerBytes to N−n writer tasks. Then, N−n writer tasks transmit data according to the amount of writerBytes for each transmission period. The control tasks 106 may not perform steps S213, S215, S229, and S231, but directly perform step S217 using the rate calculated in the above steps.

FIG. 8 is a flow chart illustrating a method of calculating a transmission rate according to an exemplary embodiment.

Referring to FIG. 8, a probe task of the transmitter 100 transmits a probe packet to the probing receiver task 208 of the receiver 200 (S301). Referring to FIG. 7, a probe task 107 is illustratively shown as transmitting probe packets D1 to D16 by respective transmission control periods.

The probing receiver task 208 forms a probe response packet for each probe packet to transmit the probe response packet to the probe task 107. Here, the probe response packet includes a forward delay, and an amount of data received by the receiver 100 up to a probe packet reception time from a transmission time.

The control task 106 calculates the average queueing delay using equation 2 (S307) and the average data reception rate using equation 3 (S305).

The control task 106 calculates the amount of queue wait data using equation 1 (S309) and the transmission rate using the amount of queue wait data (S311). For example, the control task 106 may calculate the transmission rate according to the method illustrated in FIG. 6.

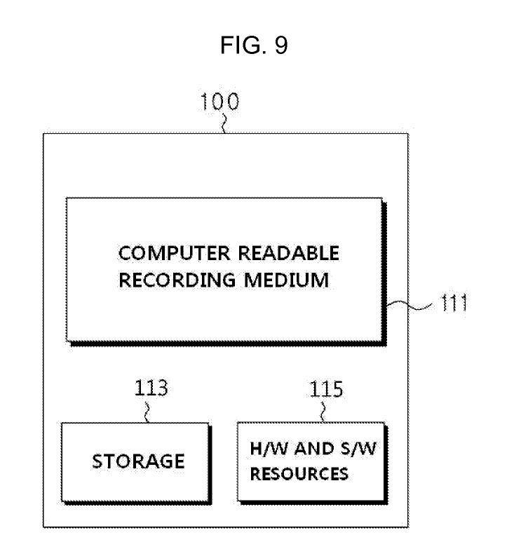

FIG. 9 is a view illustrating a computer readable recording medium according to an exemplary embodiment.

Referring to FIG. 9, the transmitter 100 may include a computer readable recording medium 111, a storage 113, and hardware (H/W) and software (S/W) resources 115.

The computer readable recording medium 111 may store the above-described transmission method and/or the transmission rate calculation method, which may be executed with the H/W and S/W resources 115.

Alternatively, the computer readable recording medium 111 may store the data transmission method or data transmission rate determination method performed by the above-described data transmitter 100, which may be executed with the H/W and S/W resources 115.

The storage 113 may store data required for the data transmission method or data transmission rate determination method, such as a minimum transmission rate, a total amount of received data, a minimum forward delay, and so on.

Hardware resources and software resources required to operate the transmitter are collectively referred to as the H/W and S/W resources 115. For example, the hardware resources may include a central processing unit (CPU), a memory, a hard disk, a network card, etc., and the software resources may include an operation system (OS) and a driver for driving hardware. For example, the control task, socket writer task, and probe task, etc. are loaded on the memory and then operated under the control of the CPU. Hardware resources and/or software resources are required to execute the tasks included in the transmitter 100. Interaction between these resources and tasks will be easily understood by those skilled in the art. Accordingly, ‘H/W and/or S/W resources’ and interaction required to operate or execute the transmitter 100 may be employed as a component of an exemplary embodiment within the scope of the present disclosure.

Like the above-described embodiments, the transmitter may operate in the fixed transmission rate operation mode or a variable operation mode in which the transmission rate varies depending on network conditions.

In the fixed transmission rate operation mode, a fixed transmission rate is maintained irrespective of cross traffic. In the minimum transmission rate operation mode, bandwidth is sufficiently utilized when there is no cross traffic, and the transmission rate is reduced by an appropriate amount but not less then the predetermined minimum transmission rate because QLength increases when the cross traffic is introduced.

In the multiple transmission rate operation mode, n is set as a predetermined value, n of N TCP streams are transmitted at a maximum transmission rate of the TCP, and N−n streams decrease the transmission rate to decrease bandwidth usage when introduction of the cross traffic is sensed (that is, when QLength is great). In this case, each TCP stream shares network bandwidth with a TCP based cross traffic at 1:1. Accordingly, the sum of the transmission rates of n streams may be maintained n times greater than the cross traffic.

In the fair transmission rate operation mode which is a special form of the multiple transmission rate operation mode, that is, n=1, N−1 streams decrease bandwidth usage when the cross stream is introduced, and 1 stream may share network bandwidth with the cross traffic to use the network bandwidth at the same ratio as the cross traffic.

According to the exemplary embodiments, the transmission rate of the cross traffic can be secured at a certain level even when the parallel TCP streams are used.

According to the exemplary embodiments, the transmission rate of the cross traffic can be prevented from being significantly reduced by effectively utilizing the network bandwidth when there is no cross traffic and decreasing network bandwidth usage by policy when the cross traffic is introduced.

According to the exemplary embodiments, data may be transmitted on the basis of 4 operation modes depending on the network conditions.

The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A data transmitter apparatus comprising:
a processing unit; and
a memory storing instructions enabling the processor to implement:
a plurality of write tasks configured to transmit data in parallel over a network to a receiver; and
a control task configured to control the plurality of write tasks to operate in one of:
a fixed transmission rate operation mode, and
a variable transmission rate operation mode in which a transmission rate varies depending on network conditions.

2. The data transmitter apparatus of claim 1, wherein the variable transmission rate operation mode comprises at least one of:
a minimum transmission rate operation mode,
a fair transmission rate operation mode, and
a multiple transmission rate operation mode.

3. The data transmitter apparatus of claim 2, wherein:
the control task sets a variable transmission rate based on network conditions; and
in the minimum transmission rate operation mode:
the plurality of write tasks transmit data at the variable transmission rate set by the control task; and
the control task sets the variable transmission rate to be no less than a predetermined minimum transmission rate.

4. The data transmitter apparatus of claim 2, wherein:
the control task sets a variable transmission rate based on network conditions;
the data transmitted from the apparatus is transmitted according to a data communication protocol having a congestion control method; and
in the fair transmission rate operation mode:
any one of the plurality of write tasks transmits data according to the congestion control method; and
the rest of the plurality of write tasks transmit data at the variable transmission rate set by the control task.

5. The data transmitter apparatus of claim 2, wherein:
the data transmitted from the apparatus is transmitted according to a data communication protocol having a congestion control method; and
in the multiple transmission rate operation mode:
fewer than all of the plurality of write tasks transmit data according to the congestion control method; and
the rest of the plurality of write tasks transmit data at the variable transmission rate set by the control task.

6. The data transmitter apparatus of claim 5, wherein the data communication protocol is TCP.

7. The data transmitter apparatus of claim 1, wherein:
each of the write tasks has a respective ID;
the respective ID of each write task of the plurality of write tasks is a positive integer assigned by the control task;
the control task assigns the respective ID to each given write task, sequentially, from 1; and
each write task makes a comparison of its respective ID with an operation mode indication value n, delivered from the control task, to determine its own respective operation mode.

8. The data transmitter apparatus of claim 7, wherein:
the control task sets a variable transmission rate based on network conditions;
the data transmitted from the apparatus is transmitted according to a data communication protocol having a congestion control method;
when the comparison indicates that the respective ID is not greater than the value n, the write task transmits data according to the congestion control method; and
when the comparison indicates that the respective ID is greater than the value n, the write task transmits data at the variable transmission rate set by the control task.

9. The data transmitter apparatus of claim 1, wherein, in the variable transmission rate operation mode:
the control task sets a variable transmission rate; and
the variable transmission rate is based on an amount of data waiting to be transmitted, during a transmission control period, in at least one queue of a data transmission path.

10. The data transmitter apparatus of claim 9, wherein the amount of data waiting to be transmitted, in the queue, is calculated using:
QLength=(MeanQueueDelay−MinFDelay)×AvgRxRate
where:
MeanQueueDelay is an average value of forward delays during a current transmission control period,
MinFDelay is a minimum value, among the forward delays up to the current transmission control period, from a transmission start time, and
AvgRxRate is an average data reception rate during the current transmission control period.

11. The data transmitter apparatus of claim 10, wherein the average data reception rate is a value obtained by dividing an amount of data received by the receiver during the current transmission control period by a duration of the transmission control period.

12. The data transmitter apparatus of claim 11, wherein the amount of data received by the receiver during the current transmission control period is a value obtained by subtracting an amount of data received by the receiver, up to a previous transmission rate control time from the transmission start time, from the amount of data received from the receiver up to the current transmission control period from the transmission start time.

13. The data transmitter apparatus of claim 1, wherein:
the processor also implements a probe task configured to:
transmit a probe packet to the receiver, and
receive a probe response packet from the receiver; and
the probe response packet comprises:
i) an indication of an amount of data transmitted to the receiver during a current transmission control period; and
ii) an indication of a forward delay of the probe packet.

14. The data transmitter apparatus of claim 13, wherein the probe task transmits the probe packet and receives the probe response packet with UDP.

15. The data transmitter apparatus of claim 13, wherein the probe task transmits a plurality of probe packets and receives corresponding probe response packets during the current transmission control period.

16. The data transmitter apparatus of claim 13, wherein the probe packet includes a respective transmission time indication.

17. The data transmitter apparatus of claim 15, wherein, in the variable transmission rate operation mode:
the control task sets a variable transmission rate;
the variable transmission rate is based on an amount of data waiting to be transmitted, during the transmission control period, in at least one queue of a data transmission path;
the amount of data waiting to be transmitted, in the queue, is calculated using:
QLength=(MeanQueueDelay−MinFDelay)×AvgRxRate
where:
MeanQueueDelay is an average value of forward delays during the current transmission control period,
MinFDelay is a minimum value among forward delays up to the current transmission control period from a transmission start time, and
AvgRxRate is an average data reception rate during the current transmission control period.

18. A data transmitter apparatus comprising:
a processing unit; and
a memory storing instructions enabling the processor to implement:
a plurality of write tasks configured to transmit data in parallel over a network to a receiver; and
a control task configured to control a data transmission rate of one or more of the plurality write tasks.

19. The data transmitter apparatus of claim 18, wherein:
the control task calculates an amount of data, waiting to be transmitted, in at least one queue of a data transmission path, using:
QLength=(MeanQueueDelay−MinFDelay)×AvgRxRate
where:
MeanQueueDelay is an average value of forward delays during a current transmission control period,
MinFDelay is a minimum value among forward delays up to the current transmission control period from a transmission start time, and
AvgRxRate is an average data reception rate during the current transmission control period; and
the control task sets the data transmission rate based on the calculated QLength,

20. The data transmitter apparatus of claim 19, wherein the average data reception rate is a value obtained by dividing an amount of data received by the receiver up to the current transmission control period from a previous transmission rate control time by a duration of the transmission control period.

21. The data transmitter apparatus of claim 20, wherein the amount of data received by the receiver during the current transmission control period is a value obtained by subtracting an amount of data received by the receiver, up to the previous transmission rate control time from the transmission start time, from the amount of data received from the receiver up to the current transmission control period from the transmission start time.

22. The data transmitter apparatus of claim 18, wherein:
the processor also implements a probe task configured to:
transmit a probe packet to the receiver, and
receive a probe response packet from the receiver; and
the probe response packet comprises:
i) an indication of an amount of data transmitted to the receiver during a current transmission control period; and
ii) an indication of a forward delay of the probe packet.

23. The data transmitter apparatus of claim 22, wherein the probe task transmits the probe packet and receives the probe response packet with UDP.

24. The data transmitter apparatus of claim 22, wherein the probe task transmits a plurality of probe packets and receives corresponding probe response packets during the current transmission control period.

25. The data transmitter apparatus of claim 22, wherein the probe packet includes a respective transmission time indication.

26. The data transmitter apparatus of claim 24, wherein, in the variable transmission rate operation mode:
the control task sets the data transmission rate to be a variable transmission rate based on an amount of data waiting to be transmitted, during a transmission control period in at least one queue on a path where the data is transmitted over the network.

27. The data transmitter apparatus of claim 26, wherein the control task calculates:
the amount of data waiting to be transmitted during the current transmission control period, in at least one queue; and
a transmission rate of a next transmission control period based on a comparison of the calculated amount of data with a threshold value.

28. The data transmitter apparatus of claim 27, wherein the amount of data, waiting to be transmitted, is calculated using
QLength=(MeanQueueDelay−MinFDelay)×AvgRxRate,
where:
MeanQueueDelay is an average value of forward delays during a current transmission control period,
MinFDelay is a minimum value among forward delays up to the current transmission control period from a transmission start time, and
AvgRxRate is an average data reception rate during the current transmission control period.

29. A data transmission method comprising:
transmitting data in parallel, by a plurality of writer tasks of a transmitter, to a receiver over a network; and
setting a transmission rate of the data based on network conditions,
wherein the transmitting of the data comprises transmitting the data in one of a fixed transmission rate operation mode, and a variable transmission rate operation mode comprising setting the transmission rate based on network conditions.

30. The data transmission method of claim 29, wherein the variable transmission rate operation mode comprises at least one of:
a minimum transmission rate operation mode,
a fair transmission rate operation mode, and
a multiple transmission rate operation mode.

31. The data transmission method of claim 30, wherein:
in the minimum transmission rate operation mode, the plurality of write tasks transmit data at the variable transmission rate set based on network conditions, the variable transmission rate being greater than a predetermined minimum transmission rate;
in the fair transmission rate operation mode, any one of the plurality of write tasks transmits data according to a congestion control method of a data communication protocol between the transmitter and the receiver, and the rest of the plurality of write tasks transmit data at the variable transmission rate set based on network conditions; and
in the multiple transmission rate operation mode, fewer than all of the plurality of write tasks transmit data according to the congestion control method, and the rest of the plurality of write tasks transmit data at the variable transmission rate set based on network conditions.

32. The data transmission method of claim 30, further comprising:
setting an operation mode indication value n,
sequentially assigning, from 1, a positive integer to each of the writer tasks as a respective ID;
making a comparison, for each of the plurality of write tasks, of the respective ID with the value n; and
setting a respective operation mode for each of the plurality of write tasks, based on a result of the comparison.

33. The data transmission method of claim 32, further comprising:
for a write task having an ID not greater than the value n, transmitting data according to a congestion control method of a data communication protocol between the transmitter and the receiver, and
otherwise, transmitting data at the transmission rate set based on network conditions.

34. The data transmission method of claim 29, wherein the setting of the transmission rate is based on an amount of data, waiting to be transmitted, during a transmission control period, in a queue of a data transmission path.

35. The data transmission method of claim 29, wherein the setting of the transmission rate comprises:
calculating the amount of data waiting to be transmitted, during a transmission control period, in a queue of a data transmission path;
comparing the calculated amount of data with a threshold value;
when the calculated amount exceeds the threshold value, setting a transmission rate of a next transmission control period as a value greater than the transmission rate of the current transmission control period; and
when the calculated amount is less than the threshold value, setting the transmission rate of the next transmission control period as a value less than the transmission rate of the current transmission control period.

36. The data transmission method of claim 34, wherein the amount of data waiting to be transmitted is calculated using
QLength=(MeanQueueDelay−MinFDelay)×AvgRxRate,
where:
MeanQueueDelay is an average value of forward delays during a current transmission control period,
MinFDelay is a minimum value among forward delays up to the current transmission control period from a transmission start time, and
AvgRxRate is an average data reception rate during the current transmission control period.

37. The data transmission method of claim 34, further comprising:
transmitting, by the transmitter, a probe packet; and
receiving, by the transmitter, a probe response packet;
wherein:
the probe response packet comprises:
i) an indication of an amount of data transmitted to the receiver during the current transmission control period; and
ii) an indication of a forward delay of the probe packet; and
the calculating of the transmission rate comprises calculating the amount of data, waiting to be transmitted, in the queue, based on the content in the probe response packet.

38. The data transmission method of claim 37, wherein the transmitting of the probe packet and the receiving of the probe response packet are performed with UDP.

39. The data transmission method of claim 37, wherein the probe packet includes a respective transmission time indication.

40. A data transmission rate determination method of a data transmitter configured to transmit data over a network, the method comprising:
calculating an amount of queue wait data, waiting during a transmission control period, in at least one queue, on a path where the data is transmitted over the network; and
setting the data transmission rate based on the amount of queue wait data.

41. The method of claim 40, wherein:
in the calculating of the amount of queue wait data, the calculation is performed with
QLength=(MeanQueueDelay−MinFDelay)×AvgRxRate
where:
MeanQueueDelay is an average value of forward delays during a current transmission control period,
MinFDelay is a minimum value among forward delays up to the current transmission control period from a transmission start time, and
AvgRxRate is an average data reception rate during the current transmission control period; and
AvgRxRate is calculated using
AvgRxRate=Recvbytes/transmission control period
where Recvbytes is the amount of data received by the receiver during the current transmission control period, and has a value obtained by subtracting an amount of data received by the receiver up to a previous transmission rate control time from the transmission start time from the amount of data received from the receiver up to the current transmission control period from the transmission start time.

42. The method of claim 40, wherein the calculating of the transmission rate comprises:
making a comparison of the calculated amount of data and a threshold value; and
when the comparison indicates that the calculated amount of data is greater than the threshold value, setting a transmission rate of a next transmission control period to have a value greater than the transmission rate of the current transmission control period; and
when the comparison indicates that the calculated amount of data is less than the threshold value, setting the transmission rate of the next transmission control period to have a value less than the transmission rate of the current transmission control period.

43. The method of claim 40, further comprising:
transmitting, by the transmitter, a probe packet; and
receiving, by the transmitter, a probe response packet;
wherein:
the probe response packet comprises:
i) an indication of an amount of data transmitted to the receiver during the current transmission control period, and
ii) an indication of a forward delay of the probe packet; and
the calculating of the amount of data comprises performing the calculation on the basis of the content of the probe response packet.

44. The method of claim 43, wherein the transmitting of the probe packet and the receiving of the probe response packet are performed with UDP.

45. The method of claim 43, wherein the probe packet includes a respective transmission time indication.

46. A non-transitory computer readable medium recording a program for executing the method according to claim 29.

47. A non-transitory computer readable medium recording a program for executing the method according to claim 40.
